(19) United States
(12) Patent Application Publication
(10) Pub. No.: US 2023/0053853 A1
(43) Pub. Date: Feb. 23, 2023

(54) SURFACE PLASMONIC SENSING

(71) Applicant: The University Court Of The University Of Glasgow, Glasgow (GB)

(72) Inventors: Alasdair Clark, Glasgow (GB); William Peveler, Glasgow (GB); Gerard Macias, Glasgow (GB); Justin Sperling, Barcelona (ES)

(21) Appl. No.: 17/797,256

(22) PCT Filed: Feb. 4, 2021
(86) PCT No.: PCT/EP2021/052628

§ 371 Date: Aug. 3, 2022

(30) Foreign Application Priority Data
Feb. 4, 2020 (GB) 2001489.0

(51) Int. Cl. G01N 21/552

(52) U.S. Cl. CPC G01N 21/554; G01N 2201/129

(57) ABSTRACT

A surface plasmonic sensing device (10) comprises a substrate (12) and a first array (20) and a second array (22) of localised surface plasmon resonance island structures (20, 22) on the substrate (12). The surface plasmon resonance island structures (20, 22) of the first (20) and second (22) array respectively have first and second surface functionalisation for selective interaction with respective analytes. The first surface functionalisation is different to the second surface functionalisation. The first (20) and second (22) arrays are interspersed with each other to provide a composite array in a main sensing region (14) of the device (10). Also disclosed is a method for manufacturing a surface plasmonic sensing device (10) and a method of analysing a fluid comprising a mixture of two or more analytes. The surface plasmonic sensing device (10) may further comprise a reference region (16) and an auxiliary sensing region (18).

### FIELD OF THE INVENTION

The present invention relates to the sensing of analytes using a surface plasmonic sensing device, and relates to the surface plasmonic sensing device itself and its method of manufacture. The invention is of particular, although not necessarily exclusive, interest in the characterisation of mixtures of analytes.

### BACKGROUND

Various known electronic sensing devices are designed to resemble and enhance the biological senses (Ref. 2). Photodetectors (Refs. 3-5), pressure and temperature sensors (Ref. 6, Ref. 7), and microphones (Ref. 9) can be related to the biological counterparts of vision, touch, and hearing, respectively. However, there are still two senses that are extremely challenging to replicate: smell and taste. These senses are highly capable for detecting individual components in complex chemical mixtures or differentiating and grouping different mixtures (Ref. 10, Ref. 11).

Chromatography is the current gold-standard for detection, identification, and classification of chemical components from complex gas (Ref. 12) and liquid (Ref. 13) mixtures. However, the nature of chromatographic identification techniques (such as liquid chromatography mass spectrometry) requires specialized laboratory equipment for the separation and analysis of a sample's chemical components. This results in costly, time-consuming, and often low throughput processes (Ref. 14) that are unsuitable for applications where real-time monitoring (or near-real-time monitoring) and/or portability are desirable (air and liquid sampling in the security, food, or drug sectors, for example). In response to these issues artificial ‘tongues’ and ‘noses’ consisting of multiple, cross-reacting sensing elements have been developed (Ref. 10, Refs. 15-19). Compared to the specialized laboratory equipment mentioned above (Ref. 12, Ref. 13), these devices are portable, highly sensitive (Ref. 20), do not require component isolation, and can be fabricated relatively cheaply (Ref. 21, Ref. 22).

### SUMMARY OF THE INVENTION

Human perceptions of taste and smell rely on multiple partially-selective chemoreceptors that result in distinct electrochemical patterns for specific flavors and odors (Ref. 23). Influenced by this mechanism, artificial tongues/noses work by combining the responses of multiple cross-reactive sensors, allowing them to identify chemical mixtures through trained pattern recognition (Ref. 15, Ref. 20) rather than by measuring absolute concentrations of specific components within the mixture (Ref. 20, Ref. 24, Ref. 25). The more sensing regions added to the analysis, the more potential the device has to differentiate between mixtures (Ref. 26). Pattern-recognition sensors such as these are extremely versatile and have found applications in medical diagnostics (Ref. 16, Refs. 27-31), environmental monitoring (Ref. 32, Ref. 33), and food-safety (Ref. 10, Ref. 17, Ref. 34).

A wide variety of materials have been used in order to construct artificial pattern-recognition sensors, including fluorescent polymers, doped metal oxides, and olfactory proteins (Ref. 25, Ref. 35, Ref. 36). Recently, surface formed plasmonic gold (Au) nanostructures have emerged as a particularly useful sensing platform for these systems thanks to their chemical stability, the sensitivity of their plasmonic resonance to environmental changes, their ease of chemical functionalization, and their easy reusability in comparison to solution phase sensing arrays (Ref. 37, Ref. 38). The optical response of Au nanostructures is dictated by their localized surface plasmon resonance (LSPR), a phenomena particularly sensitive to changes in local refractive index (Ref. 39). Partial-selectivity in these devices is achieved by using multiple arrays of nanostructures, each modified with a different surface chemistry, as individual sensing regions. When exposed to the same solution, the resonance peak-shift of each region varies due to the particular local chemical modification. Monitoring these variations results in the desired “fingerprint” for that mixture (Ref. 31). However, the need for multiple sensing regions inevitably impacts device size and measurement times. As a result, there are size, weight, and speed advantages associated with reducing the number of sensing regions required for mixture classification.

An example of a sensor device based on gold nanostructures is disclosed in US 2011/0164252 A1. The gold nanostructures are arranged as islands on a light-transmitting substrate. The gold nanostructures have surface functionalisation in order to bind to an analyte present in an analysis liquid that is brought into contact with the gold nanostructures. The sensor device is illuminated with polarised light and detected by a spectroscopic optical system. This illumination and detection is carried out before and after the analysis liquid is brought into contact with the gold nanostructures, in order to provide a reference spectrum for comparison.

The present invention aims to provide improvements over the technologies discussed above and has been devised in light of the above considerations.

Accordingly, in a first aspect, the present invention provides a surface plasmonic sensing device comprising:

a substrate;

a first array of localised surface plasmon resonance island structures on the substrate;

a second array of localised surface plasmon resonance island structures on the substrate,

wherein:

the surface plasmon resonance island structures of the first and second array respectively have first and second surface functionalisation for selective interaction with respective analytes;

the first surface functionalisation is different to the second surface functionalisation; and

the first and second arrays are interspersed with each other to provide a composite array in a main sensing region of the device.

In a second aspect, the present invention provides a method of analysing a fluid comprising a mixture of two or more analytes, including the step of providing a surface plasmonic sensing device comprising:

a substrate;

a first array of localised surface plasmon resonance island structures on the substrate;

a second array of localised surface plasmon resonance island structures on the substrate,

wherein:

the localised surface plasmon resonance island structures of the first and second array respectively have first and second surface functionalisation for selective interaction with respective analytes;

the first surface functionalisation is different to the second surface functionalisation; and

the first and second arrays are interspersed with each other to provide a composite array in a main sensing region of the device,

the method further comprising the steps:

contacting the main sensing region with said fluid comprising a mixture of two or more analytes and

thereby allowing the analytes selectively to interact with the surface functionalisations available on the first and second arrays of localised surface plasmon resonance island structures;

illuminating the main sensing region with electromagnetic radiation to cause localised surface plasmon resonance in the composite array; and

receiving reflected or transmitted electromagnetic radiation from the composite array and detecting said localised surface plasmon resonance to analyse one or more characteristics of said analytes.

In a third aspect, the present invention provides a method for manufacturing a surface plasmonic sensing device, the method comprising forming a main sensing region of the device using the steps:

providing a substrate;

forming a first array of localised surface plasmon resonance island structures on the substrate;

forming a second array of localised surface plasmon resonance island structures on the substrate,

wherein the first and second arrays are interspersed with each other to provide a composite array;

providing a first surface functionalisation on the surface plasmon resonance island structures of the first array;

providing a second surface functionalisation on the surface plasmon resonance island structures of the second array,

wherein first surface functionalisation is different to the second surface functionalisation and the first and second surface functionalisation are for selective interaction with respective analytes.

In a fourth aspect, the present invention provides a surface plasmonic sensing apparatus comprising: a surface plasmonic sensing device according to the first aspect;

a fluid contacting arrangement to allow contacting of the main sensing region with said fluid comprising a mixture of two or more analytes and thereby allowing the analytes selectively to interact with the surface functionalisations available on the first and second arrays of localised surface plasmon resonance island structures;

an illumination source for illuminating the main sensing region with electromagnetic radiation to cause localised surface plasmon resonance in the composite array; and

a detector for receiving reflected or transmitted electromagnetic radiation from the composite array and detecting said localised surface plasmon resonance to analyse one or more characteristics of said analytes.

The provision and use of a composite array as defined above has the advantage that the different surface functionalisation is available for selective interaction with the analyte (or analytes) within the same composite array and therefore can be interrogated optically together. This removes or reduces the risk of errors that would be generated by the interrogation of separate sensing devices.

Optional features of the present invention are now set out. These can be combined singly or in any combination with any aspect of the invention, unless the context demands otherwise.

The localised surface plasmon resonance island structures of the first array may be formed from a different material to the localised surface plasmon resonance island structures of the second array. For example, the localised surface plasmon resonance island structures of the first array may comprise gold and the localised surface plasmon resonance island structures of the second array may comprise aluminium. Forming the island structures using different materials permits a relatively easy approach to ensuring that the first and second arrays have different surface functionalisation, since the initial surface chemistries of the first and second arrays can be different. For example, gold can be functionalised using thiol chemistry and aluminium can be functionalised using silane chemistry.

The device may further comprise a reference sensing region. The reference sensing region may have a similar format to the main sensing region. For example, the reference sensing region may comprise: a first reference array of localised surface plasmon resonance island structures on the substrate; and a second reference array of localised surface plasmon resonance island structures on the substrate.

The surface plasmon resonance island structures of the first and second reference array may have no surface functionalisation or respectively may have different surface functionalisation compared with the main sensing region. The first and second reference arrays may be interspersed with each other to provide a composite reference array.

As for the main sensing region, the localised surface plasmon resonance island structures of the first reference array may be formed from a different material to the localised surface plasmon resonance island structures of the second reference array. For example, the localised surface plasmon resonance island structures of the first reference array may comprise gold and the localised surface plasmon resonance island structures of the second reference array may comprise aluminium.

The device may further comprise an auxiliary sensing region. The auxiliary sensing region may have a similar format to the main sensing region. For example, the auxiliary sensing region may comprise: a first auxiliary array of localised surface plasmon resonance island structures on the substrate; and a second auxiliary array of localised surface plasmon resonance island structures on the substrate.

The surface plasmon resonance island structures of the first and second auxiliary array respectively may have first and second auxiliary surface functionalisation for selective interaction with respective analytes. The first auxiliary surface functionalisation may be different to the second auxiliary surface functionalisation. One or both of the first and second auxiliary surface functionalisation of the auxiliary sensing region may be different to one or both of the first and second surface functionalisation of the main sensing region. The first and second auxiliary arrays may be interspersed with each other to provide a composite auxiliary array.

As for the main sensing region, the localised surface plasmon resonance island structures of the first auxiliary array may be formed from a different material to the localised surface plasmon resonance island structures of the second auxiliary array. For example, the localised surface plasmon resonance island structures of the first auxiliary array may comprise gold and the localised surface plasmon resonance island structures of the second auxiliary array may comprise aluminium.

The interaction of the analytes with the surface functionalisation selectively alters the refractive index around the localised surface plasmon resonance island structures to thereby selectively alter the localised surface plasmon resonance response. This is can be probed in the analysis method.

The reference sensing region may provide a reference measurement, e.g. for comparison with a measurement from the main sensing region. Accordingly, the analysis method may include the step of contacting the reference sensing region with said fluid comprising said mixture of two or more analytes. The reference sensing region may be illuminated with electromagnetic radiation to cause localised surface plasmon resonance in the composite reference array. Reflected or transmitted electromagnetic radiation may then be received from the composite reference array to detect said localised surface plasmon resonance for comparison with the main sensing region.

The auxiliary sensing region may provide an auxiliary measurement, e.g. for comparison with and/or augmentation of a measurement from the main sensing region and/or from the reference sensing region. Accordingly, the analysis method may include the step of contacting the auxiliary sensing region with said fluid comprising said mixture of two or more analytes and thereby allowing the analytes selectively to interact with the surface functionalisations available on the first and second arrays of localised surface plasmon resonance island structures. The auxiliary sensing region may then be illuminated with electromagnetic radiation to cause localised surface plasmon resonance in the composite auxiliary array. Reflected or transmitted electromagnetic radiation may then be received from the composite auxiliary array to detect said localised surface plasmon resonance to analyse one or more characteristics of said analytes and/or for comparison with the main sensing region.

In the analysis method, one or more of the main sensing region, the reference sensing region and the auxiliary sensing region may be selectively illuminated. Additionally or alternatively, reflected or transmitted electromagnetic radiation may be selectively received from one or more of the main sensing region, the reference sensing region and the auxiliary sensing region. Such approaches allow measurements to be taken only from the sensing region(s) selectively interrogated, while allowing the same fluid to make contact with each region. This further reduces the risk of introduction of errors into the analysis.

In the method for manufacturing the sensing device, the first surface functionalisation on the surface plasmon resonance island structures of the first array may be carried out with at least one reagent that makes contact with the surface plasmon resonance island structures of the first and second array. In other words, it may not be necessary to mask the second array from the first reagent, provided that the material of the island structures of the second array is suitable not to be functionalised by the first reagent.

Similarly, the second surface functionalisation on the surface plasmon resonance island structures of the second array may be carried out with at least one reagent that makes contact with the surface plasmon resonance island structures of the first and second array. In other words, it may not be necessary to mask the first array from the second reagent, provided that the material of the island structures of the first array (optionally even after functionalisation with the first reagent) is suitable not to be functionalised by the second reagent.

The shape of the island structures is not particularly limited. Typically, the island structures have the same shape as each other. For example, the island structures may be square or rectangular in plan view. They may alternatively have more acute corners, and so e.g. the island structures may have a triangular shape or a star shape. The provision of acute corners may provide advantageous response in terms of the surface plasmon resonance.

The dimensions of the islands is also not particularly limited, although is preferred to be within limits that promote surface plasmon resonance. For example, the islands may have a length (in a length direction parallel to the substrate) of not less than 20 nm, more preferably not less than 40 nm or not less than 60 nm. The islands may have a length of not more than 200 nm, more preferably not more than 150 nm. Similar consideration apply to the width of the islands (measured in a width direction, parallel to the substrate and perpendicular to the length direction). The islands may have a thickness of not less than 10 nm, and typically not more than their length.

The pitch of the islands, that is the centre-to-centre spacing of the islands, is also not particularly limited, but is preferably such that the islands have hat least translational symmetry in at least one direction. For example, the pitch of the islands may be not less than 100 nm. The pitch of the islands may be not more than 600 nm.

The first array may be arranged on a first notional lattice. The first notional lattice corresponds to the pitch of the islands, in terms of lattice spacing. The first notional lattice may be a rectangular lattice, such as a square lattice. Other lattice symmetries are possible. The second array may be arranged on a second notional lattice. Preferably, the second notional lattice corresponds to the first notional lattice except that it is offset from the first notional lattice.

The invention includes the combination of the aspects and optional features described except where such a combination is clearly impermissible or expressly avoided.

### SUMMARY OF THE FIGURES

Embodiments and experiments illustrating the principles of the invention will now be discussed with reference to the accompanying figures in which:

FIG. 1 shows an SEM of an array of monometallic Al nanostructures.

FIG. 2 shows an SEM of an array of monometallic Au nanostructures.

FIG. 3 shows an SEM of an array of bimetallic Al/Au nanostructures.

FIG. 4 shows a typical transmission spectrum for a bimetallic sensor (solid, black line) compared to equivalent monometallic sensors of Al (dotted, blue line) and Au (dotted, red line).

FIG. 5 shows a schematic cross sectional view of adjacent Au and Al nanostructures on the substrate, the Au and Al nanostructures being native.

FIG. 6 shows a schematic cross sectional view of adjacent Au and Al nanostructures on the substrate, the Au modified with DT (1-decanethiol) and the Al with HMDS (hexamethyldisilazane).

FIG. 7 shows a schematic cross sectional view of adjacent Au and Al nanostructures on the substrate, the Au modified with PFDT (1H,1H,2H,2H-perfluoro-1-decanethiol) and the Al with PEG (2-[methoxy (polyethyleneoxy)6-9 propyl] trimethoxysilane).

FIG. 8 shows the resonance shift for monometallic (bare and functionalised) sensors tested against varying refractive index media adjusted with acetone.

FIG. 9 shows the resonance shift for bimetallic (bare and functionalised) sensors tested against varying refractive index media adjusted with acetone.

FIG. 10 shows the resonance shift for monometallic (bare and functionalised) sensors tested against varying refractive index media adjusted with ethanol.

FIG. 11 shows the resonance shift for bimetallic (bare and functionalised) sensors tested against varying refractive index media adjusted with ethanol.

FIG. 12 shows PCA for organic solvent differentiation. The transmission peaks of 10 bimetallic devices (30 sensing regions) in 10%, 20%, and 30% acetone and ethanol solutions were used to generate a PCA with each sensor as a new row of the PCA.

FIG. 13 shows SEM images of various monometallic sensors, differing in terms of metal composition (Al or Au) and surface modification.

FIG. 14 shows SEM images of various bimetallic (Al and Au) sensors, differing in terms of surface modification.

FIG. 15 shows 2D PCA results for the monometallic sensors.

FIG. 16 shows 2D PCA results for the bimetallic sensors.

FIG. 17 shows the PCA scree plot for the monometallic sensors.

FIG. 18 shows the PCA scree plot for the bimetallic sensors.

FIG. 19 shows linear discriminant analysis (LDA) for the monometallic sensors.

FIG. 20 shows LDA for the bimetallic sensors.

FIG. 21 shows a schematic plan view of a surface plasmonic sensing device according to an embodiment of the invention.

FIG. 22 shows a schematic view of a surface plasmonic sensing apparatus according to an embodiment of the invention.

### DETAILED DESCRIPTION OF THE INVENTION

Aspects and embodiments of the present invention will now be discussed with reference to the accompanying figures. Further aspects and embodiments will be apparent to those skilled in the art. All documents mentioned in this text are incorporated herein by reference.

The preferred embodiments of the invention utilise metallic nanostructures. These are considered to be of particular use in optical tongue devices thanks to their chemical stability, the sensitivity of their plasmonic resonance to environmental changes, and their ease of chemical-functionalization.

The embodiments described here provide a sensing device which uses the phenomenon of localised surface plasmon resonance. It is referred to as a surface plasmonic sensing device and also as an “optical tongue” device. The device is preferably reusable. The device comprises multiplexed gold and aluminium nano-arrays. This can be considered to be a bimetallic device which produces two distinct resonance peaks for each sensing region. Through specific modification of these plasmonic arrays with orthogonal surface chemistries, a dual-resonance device is demonstrated that reduces sensor size and data-acquisition times when compared to single-resonance, monometallic devices.

In a demonstration of the operation of the embodiments of the invention, the optical tongue devices have been used to differentiate commercial whiskies with >99.7% accuracy by means of linear discriminant analysis (LDA).

This advance in device miniaturization, functionalization, and multiplexed readout allows the devices disclosed here to have applications in chemical mixture identification, in particular where portability, reusability, and measurement speed are of interest.

In the embodiment described below, a reusable optical tongue device has three sensing regions. Each sensing region is capable of obtaining two partially selective responses from a single measurement. Each region consists of two superimposed nanoplasmonic arrays featuring two distinct metals: gold (Au) and aluminium (Al). This allows for the orthogonal chemical-functionalization of each superimposed array via thiol (Au) (Refs. 40-42) and silane (Al) (Ref. 41, Ref. 43) chemistries, while also allowing us to obtain two resonance peak-shifts using a single optical measurement. Compared to a device containing its monometallic counterparts, we demonstrate that our device containing bimetallic Au/Al sensors can halve the number of sensing elements required (reducing device size and number of regions to probe [i.e. data acquisition time]) without compromising the identification and classification capabilities of the device. We go on to show that these sensors can be used as an optical tongue to distinguish between seven different whiskies and three controls.

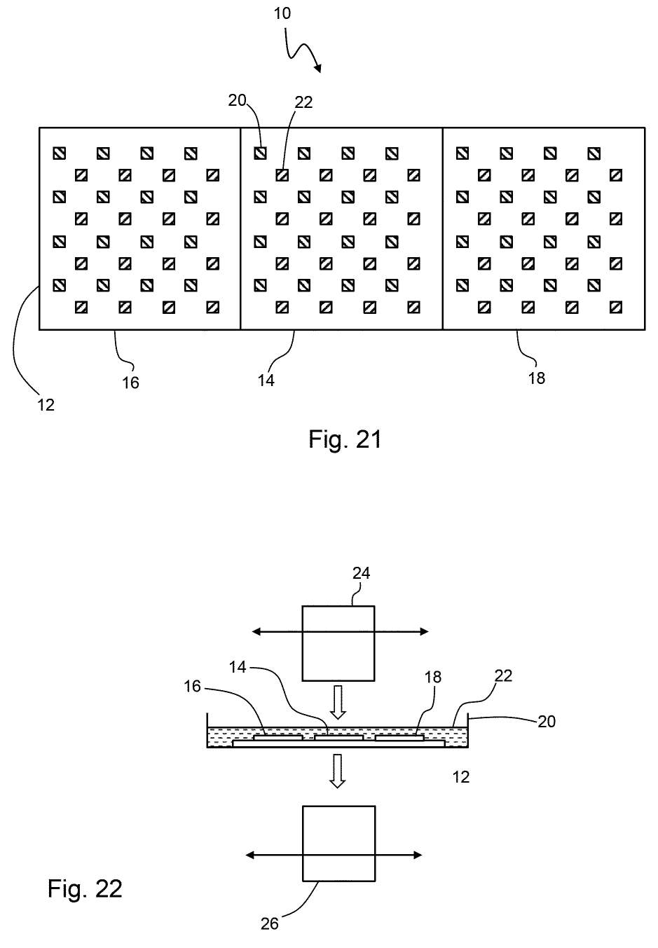

FIG. 21 shows a schematic plan view of a surface plasmonic sensing device 10 according to an embodiment of the invention. The device comprises a substrate 12, typically based on glass. The device has a main sensing region 14, a reference sensing region 16 and an auxiliary sensing region 18. Taking the main sensing region first, this has a first array of localised surface plasmon resonance island structures 20 on the substrate and a second array of localised surface plasmon resonance island structures 22 on the substrate. In this embodiment, each localised surface plasmon resonance island structure is a metallic nanostructure, having a square shape in plan view. Also in this embodiment, the first array is formed of Au nanostructure and the second array is formed of Al nanostructures. The surface plasmon resonance island structures of the first and second array respectively have first and second surface functionalisation for selective interaction with respective analytes. The first surface functionalisation is different to the second surface functionalisation. As can be seen in FIG. 21, the first array is based on a square lattice arrangement and the second array is based on a similar square lattice arrangement. The first and second arrays are interspersed with each other to provide a composite array.

The reference sensing region 16 is similar to the main sensing region except that the surface plasmon resonance island structures of the first and second reference array have no surface functionalisation.

The auxiliary sensing region 18 is similar to the main sensing region except that the surface plasmon resonance island structures of the first and second auxiliary array have different surface functionalisation to the surface plasmon resonance island structures of the first and second array of the main sensing region.

FIG. 22 shows a schematic view of a surface plasmonic sensing apparatus according to an embodiment of the invention. The surface plasmonic sensing device, having main sensing region 14, a reference sensing region 16 and an auxiliary sensing region 18 is disclosed in a receptacle 20 that constitutes a fluid contacting arrangement to allow contacting of the sensing regions 14, 16, 18 with fluid 22 comprising a mixture of two or more analytes. The analytes thereby selectively interact with the surface functionalisations available on the localised surface plasmon resonance island structures. Illumination source 24 (typically a broadband illumination source) is positionable selectively to illuminate the main sensing region 14, the reference sensing region 16 and the auxiliary sensing region 18. The receptacle 20 is formed of light-transmissive material, as is the substrate 12 of the device, and therefore detector 26 is located to receive transmitted light from the device to detect said localised surface plasmon resonance to analyse one or more characteristics of said analytes. Detector 26 is also positionable selectively to interrogate the main sensing region 14, the reference sensing region 16 and the auxiliary sensing region 18.

Device Fabrication

Devices were fabricated using electron-beam lithography and metal-evaporation. Nanosquares of 100 nm×100 nm, with a 300 nm period in X and Y orthogonal directions were patterned into a resist bi-layer of poly(methyl methacrylate) (PMMA) resist 2010 and PMMA 2041 (total thickness 150 nm) using a Vistec VB6 Ultra High Resolution Extra Wide Field electron beam lithography tool. Following development of the pattern, a 2/50 nm Ti/Au layer was evaporated onto the sample using a Plassys MEB 400S/550S electron-beam evaporation tool. These fabrication steps were then repeated to add 50 nm thick Al nanostructures.

Surface Functionalization

The bimetallic device consisted of 3 Al/Au nanoarray regions. To create different localized environments for each region of the device, surface chemistry modifications were made.

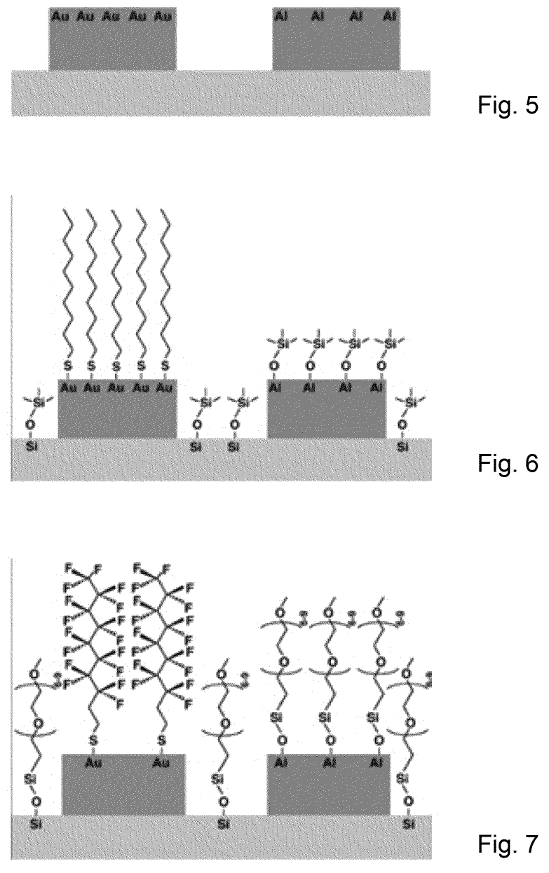

The first array consisted of unmodified Au and Al (with its native oxide layer). For these arrays, the base substrate was borosilicate glass (FIG. 5).

For the second array, exposed sensor regions were immersed in a 10 mM ethanolic solution of 1-decanethiol (DT, Sigma-Aldrich) for 24 hours, rinsed three times with ethanol and dried with nitrogen. Hexamethyldisilazane (HMDS, Sigma-Aldrich) was then spun on at 4000 RPM for 60 seconds, allowed to air-dry for 2 minutes, and the excess was washed off. This produced the Au-DT and Al-HMDS surfaces (FIG. 6). For these regions, the base substrate was modified to glass-HMDS.

For the third array, exposed sensor regions were immersed in a 10 mM ethanolic solution of 1H,1H,2H,2H-perfluoro-1-decanethiol (PFDT, Sigma Aldrich) for 24 hours, rinsed three times with ethanol and dried with nitrogen. The exposed regions were then immersed in a 0.5% solution (by volume) of 2-[methoxy (polyethyleneoxy)6-9 propyl] trimethoxysilane (PEG, Sigma-Aldrich) in toluene for 1 hour, rinsed three times with toluene, followed by rinsing three times with deionised water. The substrate was then nitrogen dried, and oven-baked at 100° C. for 30 minutes to produce the Au-PFDT and Al-PEG surfaces (FIG. 7). For these regions, the base substrate was modified to glass-PEG.

A monometallic device consisting of 6 nanoarray regions (3 Al and 3 Au) was fabricated for comparison. The same surface modifications were made to create the six sensing regions of Al, Au, Al-HMDS, Au-DT, AIPEG, and Au-PFDT.

For all of the devices, shifts of the transmission spectra (in water) due to the surface chemistry modifications were measured.

Solution Preparation

Solutions of 10%, 20%, and 30% acetone (by volume) and 10%, 20%, 30%, and 40% ethanol (by volume) in deionised water were prepared. The selection of whiskies and vodka in Table 1 were purchased from their respective distilleries.

TABLE 1
Alcohols tested

| ID | Name | Serial Number | % | Type | Region | Barrel | Malt | Age |
|---|---|---|---|---|---|---|---|---|
| 0 ○ | DI H₂O | — | 0 | Deionized | — | — | — | — |
| | | | | Water | | | | |
| E [symbol] | 40% Ethanol in | — | 40 | Deionized | — | — | — | — |
| | DI H₂O (v/v) | | | Water/ | | | | |
| | | | | Ethanol | | | | |
| | | | | Mixture | | | | |
| V 0 | Absolut ® | L20180109H1 16:07 | 40 | Vodka | — | — | — | — |
| W1 + | Glenfiddich ® 12 | L33B465421080841 | 40 | Scotch | Speyside | Amer. Oak/ | Single | 12 |
| | y | | | Whisky | | Eur. Sherry | | |
| W2 Δ | Glenfiddich ® 15 | L33B446630051142 | 40 | Scotch | Speyside | Eur. Sherry/ | Single | 15 |
| | y | | | Whisky | | Solera Vat | | |
| W3 ⋄ | Glenfiddich ® 18 | L33B462719071531 | 40 | Scotch | Speyside | Amer. Oak/ | Single | 18 |
| | y | | | Whisky | | Span. | | |
| | | | | | | Oloroso | | |
| W4 + | Glen Marnoch ® | LBB6B1406 021117 | 40 | Scotch | Highland | Amer. Oak/ | Single | — |
| | Sherry Cask | 15:44 | | Whisky | | Eur. Sherry | | |
| W5 Δ | Glen Marnoch ® | LBB6B1405 021117 | 40 | Scotch | Highland | Amer. Oak/ | Single | — |
| | Bourbon Cask | 19:42 | | Whisky | | Bourbon | | |
| W6 ⋄ | Glen Marnoch ® | LBB6B1407 021117 | 40 | Scotch | Highland | Amer. Oak/ | Single | — |
| | Rum Cask | 17:53 | | Whisky | | Caribbean | | |
| | | | | | | Rum | | |
| W7 ⋄ | Laphroaig ® 10 y | L6262MB2 22990853 | 40 | Scotch | Islay | Bourbon | Single | 10 |
| | | | | Whisky | | | | |

Experimental Setup

A polydimethylsiloxane (PDMS) chamber on a glass slide was filled with each solution and samples were submerged in the chamber and slightly agitated for 2 minutes. A custom-built micro-spectrophotometer was used to measure the real-time transmission spectra (0.5 nm resolution). Light from a VIS-NIR light source (tungsten-halogen 400 to 1200 nm wavelength) was used to probe each element of the sensor. A 10× objective was used to couple the transmitted light into an optical-fiber attached to a StellarNet Microspectrophotometer (StellarNet Blue Wave). With this objective, the spot size of the optical fiber is around 45 μm. For ease of measurement, each element in the sensor was thus fabricated to be 300 μm² in size. For the acetone and ethanol solvent differentiation, three different preparations of each solvent were made, and subsequent transmission spectra were taken. For the alcohol differentiation experimentation, thirty transmission spectra per sensor region, for each solution, were measured. Between measurements, samples were rinsed in water, then ethanol, and nitrogen dried. A baseline measurement of a “blank” region the sample was used prior to measuring an element in one of the tongue arrays for background correction.

Data Analysis

MATLAB was used to analyze the transmission spectra. The transmission spectrum was smoothed (20 points, meanaverage smoothing) and interpolated (from 0.5 nm to 0.01 nm). The peak position value of the minima peaks (one for each monometallic element and two for each bimetallic element) was determined. The resulting transmission peak values (wavelength in nanometers) were arranged in a data matrix, where the rows of the matrix corresponded to a particular solution and the columns corresponded to the wavelength of the resonant peaks for each chemistry—Au, Al, Au-DT, Al-HMDS, Au-PFDT, Al-PEG. The data matrix was first analyzed using the inherent principal component analysis (PCA) function in MATLAB (by singular value decomposition algorithm). The variance for the scree plot was obtained from the MATLAB PCA result set. Linear discriminant analysis (LDA) was then performed on the same data matrix using Systat 13 software.

Result and Discussion

Our bimetallic sensor consists of two arrays of square nanostructures organized in a “checkerboard”-like arrangement; one array constructed with Au, the other with Al. This configuration was chosen so that the device displayed two well-resolved peaks in the visible spectrum, with low transmission at their respective minima. The bimetallic sensor was fabricated on a borosilicate-glass substrate via a multi-step electron-beam lithography process.

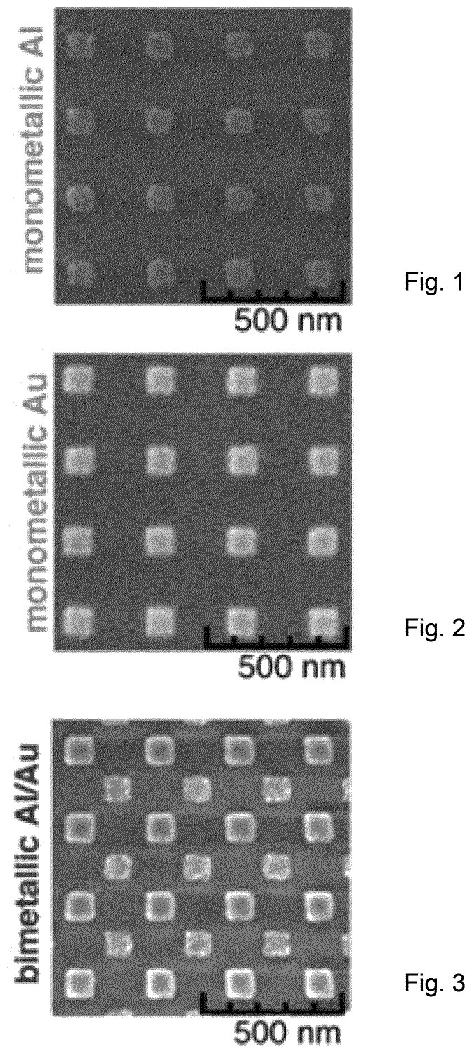

FIG. 1 shows an SEM of an array of monometallic Al nanostructures. FIG. 2 shows an SEM of an array of monometallic Au nanostructures. FIG. 3 shows an SEM of an array of bimetallic Al/Au nanostructures.

In the SEM images of FIGS. 1-3, the two metals can be differentiated due to their distinct electron scattering properties, Au being ‘brighter’ than Al (Ref. 44).

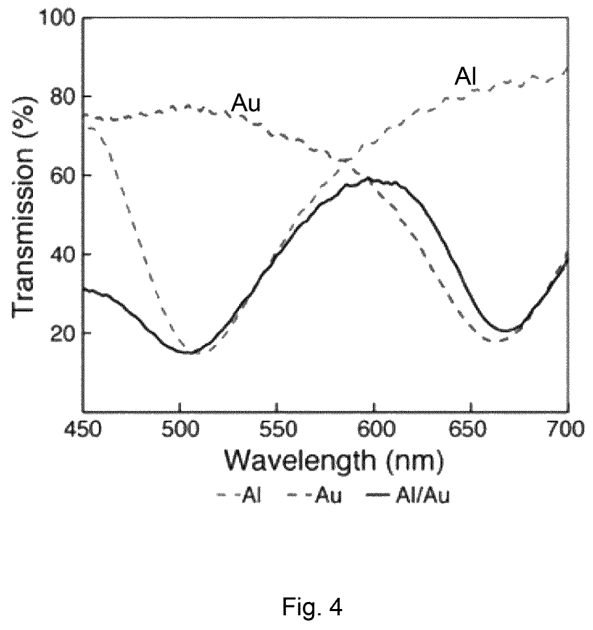

FIG. 4 shows a typical transmission spectrum for a bimetallic sensor (solid, black line) compared to equivalent monometallic sensors of Al (dotted, blue line) and Au (dotted, red line). As confirmed by the spectra of the two monometallic sensors, the two peaks in the bimetallic transmission spectrum at 500 nm and 660 nm correspond to Al and Au, respectively. The transmission spectra were measured in water.

Both Au and Al can support selective functionalization of their surfaces. While the Au nanostructures can be readily modified by thiol chemistry (Refs. 40-42), the native oxide layer present on the Al nanostructures displays —OH groups which enables modification via silane chemistry (Ref. 41, Ref. 43). The presence of organic ligands on plasmonic arrays is known to influence the extent to which certain organic molecules interact with the arrays, thus affecting the refractive index around the nanostructures and in-turn their resonant properties (Ref. 37). While monometallic sensor arrays with single-ligand modifications have been reported (Ref. 31), bimetallic arrays that allow dual-ligand modifications have yet to be explored, to the knowledge of the inventors.

Our system comprised 3 bimetallic sensor arrays, each exhibiting unique surface chemistries: a sensor consisting of native Au and Al (FIG. 5); a sensor where the Au was modified with DT (1-decanethiol) and the Al with HMDS (hexamethyldisilazane) (FIG. 6); and a sensor where the Au was modified with PFDT (1H,1 H,2H,2H-perfluoro-1-decanethiol) and the Al with PEG (2-[methoxy (polyethyleneoxy)6-9 propyl] trimethoxysilane) (FIG. 7).

These surface chemistries were chosen to represent varied levels of hydrophobicity/philicity and different chemical functionalities. Altering the surface chemistry of the nanostructures affects how individual chemical components in a mixture interact with the structures, altering their optical response. In addition to this “bimetallic” sensor array, a corresponding array of 6 equivalent monometallic sensors of Au and Al were also produced, matching the chemistries used on the bimetallic sensors (i.e. 3 Au arrays and 3 Al arrays).

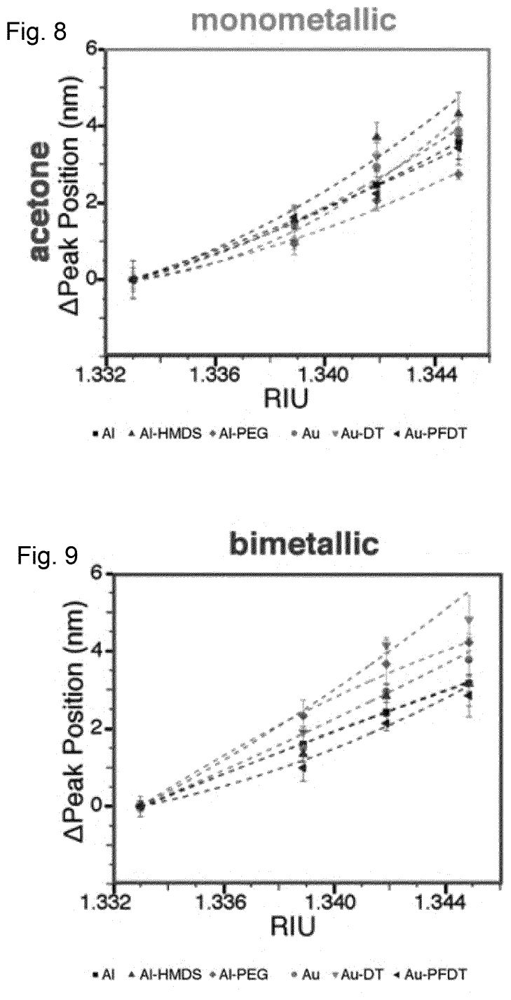

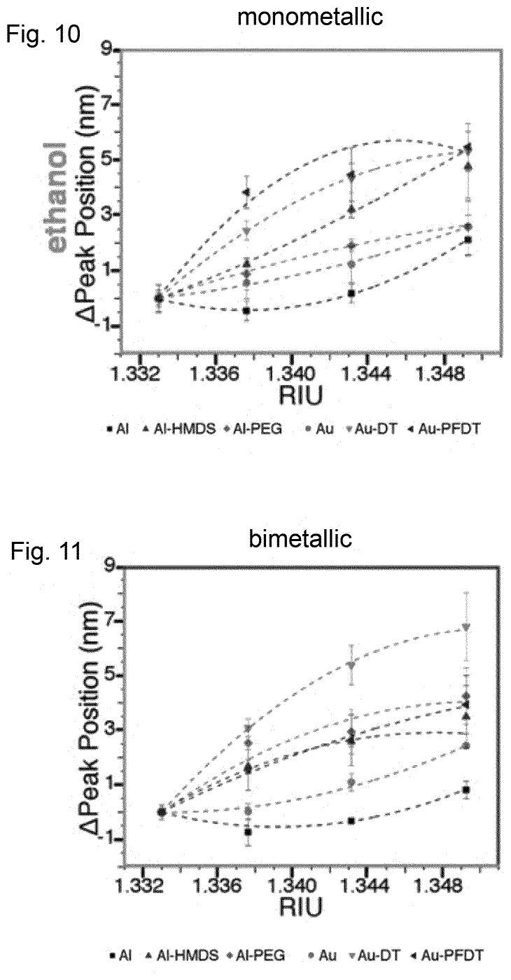

The monometallic (FIGS. 8 and 10) and bimetallic (FIGS. 9 and 11) sensors were tested against varying refractive index media adjusted with acetone (FIGS. 8 and 9) and ethanol (FIGS. 10 and 11). The resulting resonance shifts from water (RIU=1.333) were compared using RIU values for acetone (Ref. 1) and ethanol (Ref. 8) solutions. Accordingly, FIGS. 8-11 show the shift in plasmonic response from water for monometallic and bimetallic arrays in 10%, 20%, and 30% solutions (v/v) of (i) acetone and (ii) ethanol. The different surface chemistries (native Al, Al-HMDS, Al-PEG, native Au, Au-DT, and Au-PFDT) alter the plasmonic peak of the nanostructures when exposed to the same organic solvent. This results in different peak-shifted curves. The RIU values for acetone and ethanol solutions were obtained from Ref. 1 and Ref. 8, respectively. For FIGS. 8-11, the lines are present to guide the eye and the error bars are one standard deviation from the average.

Three trends were identified:

(1) Regardless of the metallic composition of the nanostructures, the organic solvent used to modify the refractive index, or whether the region is monometallic or bimetallic, the sensitivity curve depends on the organic ligand present on the nanostructure (e.g. the Al, Al-HMDS, and Al-PEG curves in FIG. 8 are different).

(2) For any given surface chemistry on either the monometallic or bimetallic sensor, the sensitivity curve depends on the type of organic solvent used to alter the refractive index rather than just shifting with RIU alone (e.g. the Al-HMDS curves in FIG. 8 and FIG. 10 are not the same.)

(3) The sensitivity curves of the monometallic and bimetallic sensor for the same metal composition, organic ligand, and organic solvent, differ; the bimetallic sensors response is fundamentally different from its monometallic counterparts (e.g. the Al-HMDS sensitivity curves in FIG. 8 and FIG. 9 are not the same.)

In all three cases, we attribute these behaviours to the segregation of the solvent at the sensor-liquid interface and corresponding changes to the local refractive index. Solvent segregation is dependent on the chemical groups present at the interface (Ref. 45); using different metals and different ligands on the surface results in different segregation behaviour, which likely explains the different plasmonic responses. This is especially important when comparing the monometallic and bimetallic responses; the presence of a second metal and second ligand results in additional differential solvent segregation behaviour. These results confirm that we can tailor the partial selectivity of the device via the orthogonal silane and thiol chemistry.

To further verify the applicability of the bimetallic approach for implementation as an optical tongue device, we performed a principal component analysis (PCA—a non-biased, multivariant analysis technique) (Ref. 19, Ref. 46) across 10 different bimetallic ‘tongues’ using the data from our acetone/ethanol test. Each bimetallic tongue consisted of three element pairs: Al/Au, AIHMDS/Au-DT, and Al-PEG/Au-PFDT. For the PCA, each row corresponded to a particular solvent tested, and each column corresponded to the transmission peak minimum for each surface chemistry.

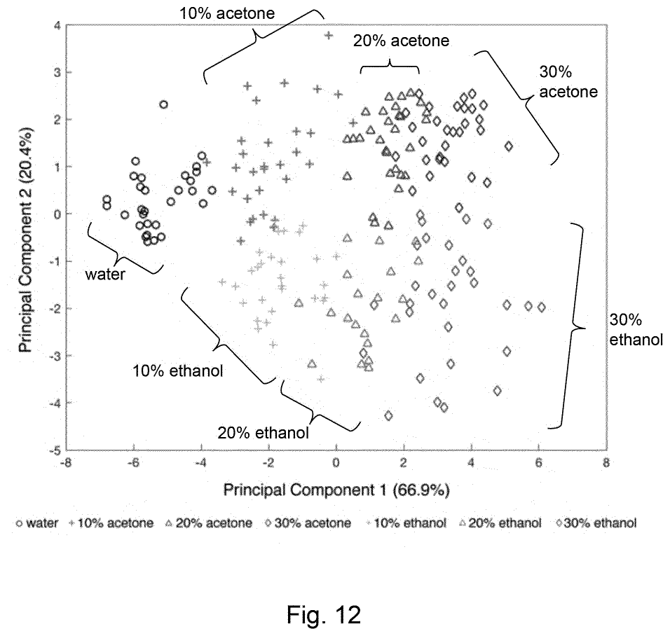

FIG. 12 shows the PCA of the first two principal components (that explain 87.3% of the total variance), where black dots represent DI water, red dots represent acetone-based media and yellow dots represent ethanol-based media. These results show that by combining the response of multiple surface chemistries on our bimetallic sensors, we are able to cluster the results from each solution into a map.

While delineation of classes (acetone/ethanol and the v/v percent of each) is shown, it is important to note that this PCA analyzed the results across 10 different optical tongue devices. A close look at SEM images of each of these devices revealed that, while within the specifications of our e-beam lithography tool (i.e. 20 nm spatial resolution), the X-Y distances between the two metals was slightly different in each device. Given the high sensitivity of plasmonic nanostructures to their near-field environment, such minute misalignments can result in slight differences from sensor to sensor (Ref. 47, Ref. 48) and has been confirmed by simulations carried out by the present inventors.

Additionally, variations in position between the Al and Au arrays can alter the surface wettability and segregation properties. This is because the distribution of hydrophobic and hydrophilic groups is dependent on the position of the metals and their specific modified surface chemistries within the array (Ref. 49). Thus, the spread of points within each class in the PCA is most likely attributed to this fabrication resolution. Regardless, the PCA shows ordering of the different solutions by combining the response from three sensing regions, which constitutes the basic requirement for the development of an artificial tongue. Similar behaviour was observed with comparable monometallic sensors (six sensing regions).

To further demonstrate the capabilities of the bimetallic tongue, we used one device to differentiate between seven different whiskies with identical ethanol contents (40%), a 40% vodka, and 40% ethanol in water, with water as the control (as shown in Table 1). This test was performed on a single bimetallic array to minimize the variance between sensors that would increase the noise within the data. The resulting response of the bimetallic array was compared to an equivalent monometallic array (containing six sensing regions).

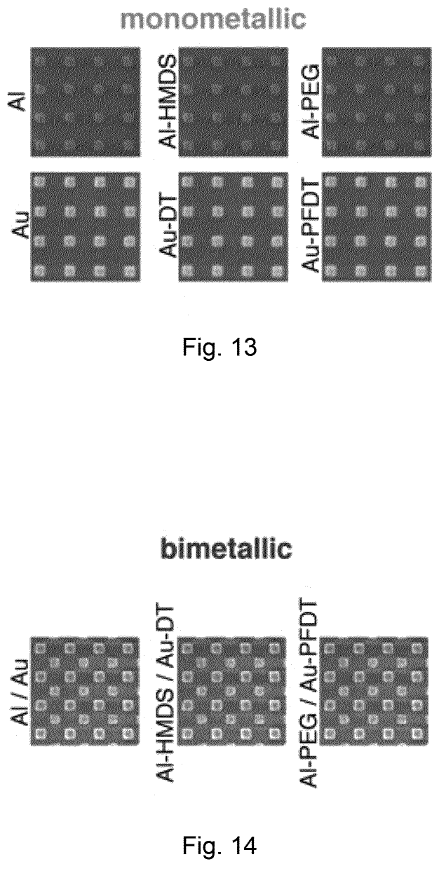

FIG. 13 shows SEM images of various monometallic sensors, differing in terms of metal composition (Al or Au) and surface modification. FIG. 14 shows SEM images of various bimetallic (Al and Au) sensors, differing in terms of surface modification.

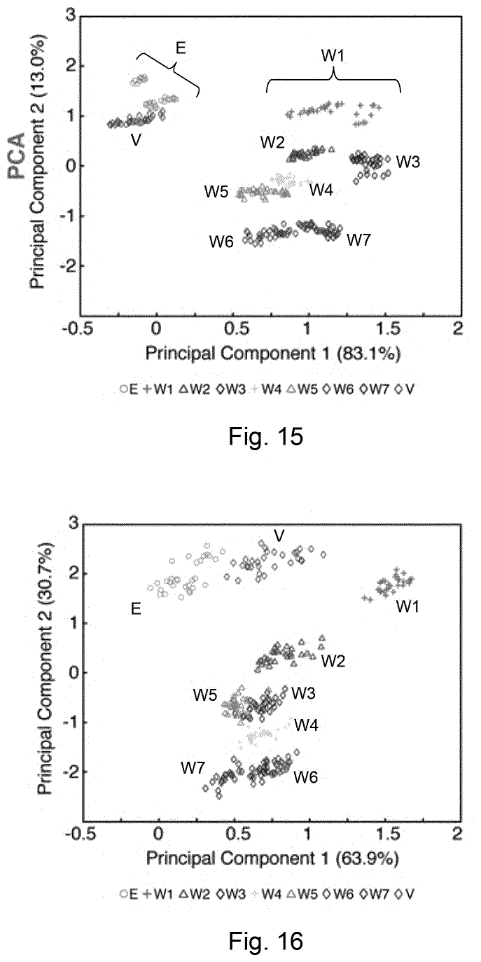

FIG. 15 shows 2D PCA results for the monometallic sensors. FIG. 16 shows 2D PCA results for the bimetallic sensors. Note that these PCAs show only the alcoholic solutions; water is off the axis set.

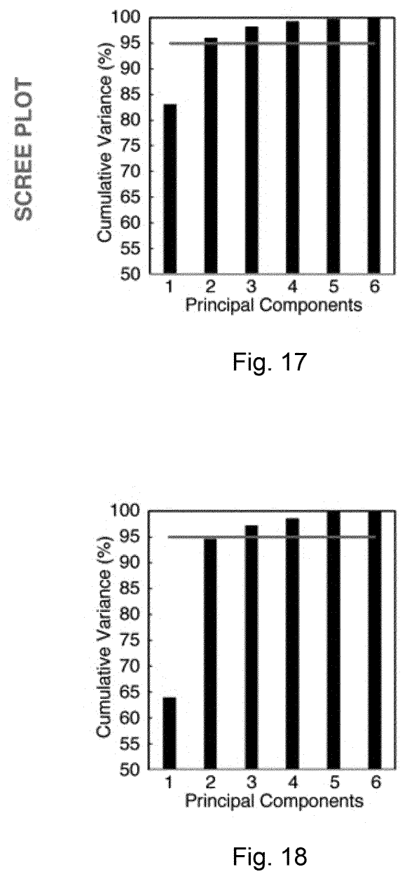

FIG. 17 shows the PCA scree plot for the monometallic sensors. FIG. 18 shows the PCA scree plot for the bimetallic sensors.

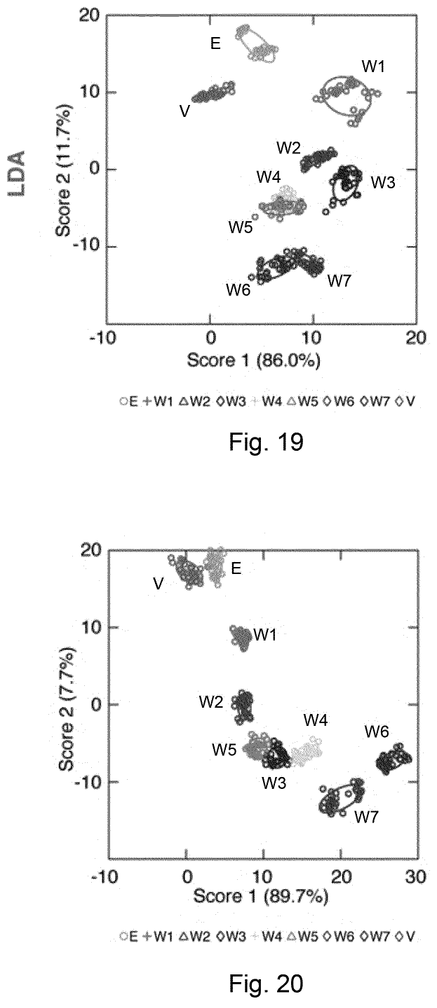

FIG. 19 shows linear discriminant analysis (LDA) for the monometallic sensors. FIG. 20 shows LDA for the bimetallic sensors. The confidence ellipses for the LDA are one standard deviation.

Note that in FIGS. 15, 16, 19 and 20, colours are used. These are identified by the first column in Table 1.

Sensor performance is determined by the dimensionality of the PCA, the distance between the groupings, and ‘tightness’ of the groupings. The dimensionality is measured by the number of components required to account for 95% of measurement variance, as shown in FIG. 15 and FIG. 16. For the plasmonic tongue comprised of six monometallic sensors, two dimensions (principal components) contained >95% variance; and for the plasmonic tongue comprised of three bimetallic sensors, the first two principal components (PCs) contained 94.6% variance (with >95% of the variance over three dimensions). The overall difference between the cumulative variance of monometallic and bimetallic tongues with two principal components is very small. In both cases, the important qualitative point is that the PCA algorithm shows distinct differentiation of the different test solutions with large spacings between these groupings.

In both PCA analyses (mono-versus bimetallic) the pattern of water versus whisky and ethanol/vodka versus whisky is largely similar. W1 (Glenfiddich® 12y) in particular gives a markedly different signal to the other spirits tested. Analysis of the PCs in each tongue give an indication of the elements contributing to the sensor response. It was found that, for the monometallic tongue, PC1 is from the transmission peaks corresponding to the Au nanostructures, particularly Au and Au-PFDT that separate water from ethanolic solutions. Al-HDMS contributes to the PC2, along with Al which has the most separation of the whiskies/controls. In the bimetallic tongue, many chemical functionalities contribute to the PC1, leading to the separation of the water and whiskies as well as improved separation between vodka and ethanol solution, but PC2 is dominated by Al and Al-PEG, demonstrating that by combining the surface chemistries in a single device, very different behaviour is observed.

In this sensor configuration we hypothesize (without wishing to be bound by theory) that whilst the main driver in the solution fingerprints is clearly the EtOH content (vs water), the trace differences between a pure EtOH solution and the compounds present in the spirits are causing significant signal variations. These compounds include the additional alcohols present in whiskies (propanols and butanols), organic aromatic components (phenols, terpenes and vanillin), and aliphatics (lactones). Each of these components will have different interactions with the sensor surface coatings dependent on their partial solubility and hydrophobicitiy/phillicity. It is proposed the most hydrophilic components will interact favorably with the bare Al and PEG surfaces, whilst the most hydrophobic will prefer to interact with the Au and Au-DT surfaces. Factors such as pH or ionic strength may also contribute to the subtle changes seen on the sensor chips.

After analyzing the PCA and discrimination capabilities of both mono- and bimetallic tongues, we can conclude that both tongues are able to differentiate between the whiskies tested thanks to the functional groups present on their surface. To investigate whether formal classification was possible, linear discriminant analysis (LDA), a supervised technique, was applied to the data to generate new “scores” (in a similar methodology to PCA) to maximize separation between known clusters whilst minimizing variance within each cluster (50). Both the monometallic (FIG. 19) and bimetallic (FIG. 20) tongues performed excellently and could classify (using leave-one-out cross validation to test accuracy) 100% and 99.7% of the data, respectively. Although the bimetallic tongue confused one instance of W3 for W5, this was arguably compensated for by its ability to provide two signals from one measurement and therefore make half the number of measurements required to collect the data, requiring less sample volume. Additionally, the greater cross-reactivity on these sensor elements increases the potential for tuning and improving the fingerprint responses by incorporating different pairings of surface chemistry

In conclusion of this section, presented here is a reusable bimetallic nanoplasmonic tongue that displays two distinct resonance peaks per region and whose orthogonal surface chemistries can be selectively modified to tune their ‘tasting’ sensitivity. These unique features have enabled the reduction (halving in this example) of both the sensor size and necessary data-acquisition time while still providing dataset clustering upon PCA and successful classification with LDA. This is a versatile system, allowing the development of high quality nanoplasmonic tongues for any given application via simple alterations to the chosen surface ligands and/or plasmonic metals in order to produce new sensors with unique chemical responses. Accordingly, the devices disclosed can be used in portable apparatus for applications in a point of care diagnostics, counterfeit detection in high-value drinks, environmental monitoring, and defence.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

### REFERENCES

A number of publications are cited above in order to more fully describe and disclose the invention and the state of the art to which the invention pertains. Full citations for these references are provided below. The entirety of each of these references is incorporated herein.

1. Kurtz S S, Wikingss.Ae, Camin D L, Thompson A R. REFRACTIVE INDEX AND DENSITY OF ACETONE-WATER SOLUTIONS. Journal of Chemical and Engineering Data. 1965; 10(4):330

2. del Valle M. Bioinspired Sensor Systems. Sensors. 2011; 11(11):10180-6.

3. Stockmann F. PHOTODETECTORS, THEIR PERFORMANCE AND THEIR LIMITATIONS. Applied Physics. 1975; 7(1):1-5.

4. Laux E, Genet C, Skauli T, Ebbesen T W. Plasmonic photon sorters for spectral and polarimetric imaging. Nature Photonics. 2008; 2(3):161-4.

5. Dong X, Huang X, Zheng Y, Shen L, Bai S. Infrared dim and small target detecting and tracking method inspired by Human Visual System. Infrared Physics & Technology. 2014; 62:100-9.

6. Lipomi D J, Vosgueritchian M, Tee B C K, Hellstrom S L, Lee J A, Fox C H, et al. Skin-like pressure and strain sensors based on transparent elastic films of carbon nanotubes. Nature Nanotechnology. 2011; 6(12):788-92.

7. Lumelsky V J, Shur M S, Wagner S. Sensitive Skin. IEEE Sens J. 2001; 1(1):41-51.

8. Scott T A. REFRACTIVE INDEX OF ETHANOL-WATER MIXTURES AND DENSITY AND REFRACTIVE INDEX OF ETHANOL-WATER-ETHYL ETHER MIXTURES. J Phys Chem. 1946; 50(5):406-12.

9. Zhang Y, Bauer R, Jackson J C, Whitmer W M, Windmill A F C, Uttamchandani D. A Low-Frequency Dual-Band Operational Microphone Mimicking the Hearing Property of Ormia Ochracea. Journal of Microelectromechanical Systems. 2018; 27(4):667-76.

10. Rodriguez-Mendez M L, De Saja J A, Gonzalez-Anton R, GarciaHernandez C, Medina-Plaza C, Garcia-Cabezon C, et al. Electronic Noses and Tongues in Wine Industry. Frontiers in Bioengineering and Biotechnology. 2016; 4.

11. Guerrini L, Garcia-Rico E, Pazos-Perez N, Alvarez-Puebla R A. Smelling, Seeing, Tasting-Old Senses for New Sensing. Acs Nano. 2017; 11(6):5217-22.

12. Jennings W, Shibamoto T. Qualitative Analysis of Flavor and Fragrance Volatiles by Glass Capillary Gas Chromatography. 1 ed: Elsevier; 2012.

13. Ng S C, Ong T T, Fu P, Ching C B. Enantiomer separation of flavour and fragrance compounds by liquid chromatography using novel urea-covalent bonded methylated beta-cyclodextrins on silica. Journal of Chromatography A. 2002; 968(1-2):31-40.

14. Welch C J, Wu N, Biba M, Hartman R, Brkovic T, Gong X, et al. Greening analytical chromatography. Trac-Trends in Analytical Chemistry. 2010; 29(7):667-80.

15. Kermani B G, Schiffman S S, Nagle H T. Performance of the Levenberg-Marquardt neural network training method in electronic nose applications. Sens Actuators, B. 2005; 110(1):13-22.

16. D'Amico A, Pennazza G, Santonico M, Martinelli E, Roscioni C, Galluccio G, et al. An investigation on electronic nose diagnosis of lung cancer. Lung Cancer. 2010; 68(2):170-6.

17. Han J, Ma C, Wang B, Bender M, Bojanowski M, Hergert M, et al. A Hypothesis-Free Sensor Array Discriminates Whiskies for Brand, Age, and Taste. Chem. 2017; 2(6):817-24.

18. Mimendia A, Gutierrez J M, Leija L, Hernandez P R, Favari L, Munoz R, et al. A review of the use of the potentiometric electronic tongue in the monitoring of environmental systems. Environmental Modelling & Software. 2010; 25(9):1023-30.

19. Askim J R, Mahmoudi M, Suslick K S. Optical sensor arrays for chemical sensing: the optoelectronic nose. Chem Soc Rev. 2013; 42(22):8649-82.

20. Peveler W J, Yazdani M, Rotello V M. Selectivity and Specificity: Pros and Cons in Sensing. Acs Sensors. 2016; 1(11):1282-5.

21. Persaud K, Dodd G. ANALYSIS OF DISCRIMINATION MECHANISMS IN THE MAMMALIAN OLFACTORY SYSTEM USING A MODEL NOSE. Nature. 1982; 299(5881):352-5.

22. Lu C, Lipson R H. Interference Lithography: A Powerful Tool for Fabricating Periodic Structures. Laser & Photonics Reviews. 2010; 4(4):568-80.

23. Vosshall L B, Stocker R E. Molecular architecture of smell and taste in Drosophila. Annual Review of Neuroscience. 2007; 30:505- 33.

24. Anslyn E V, Rotello V M. Chemosensory models: approaches and applications of differential sensing Editorial overview. Current Opinion in Chemical Biology. 2010; 14(6):683-4.

25. Li Z, Askim J R, Suslick K S. The Optoelectronic Nose: Colorimetric and Fluorometric Sensor Arrays. Chem Rev. 2019; 119(1):231-92.

26. Goodner K L, Dreher J G, Rouseff R L. The dangers of creating false classifications due to noise in electronic nose and similar multivariate analyses. Sens Actuators, B. 2001; 80(3):261-6.

27. Turner A P F, Magan N. Electronic noses and disease diagnostics. Nature Reviews Microbiology. 2004; 2(2):161-6.

28. Geng Y, Peveler W J, Rotello V M. Array-based “Chemical Nose” Sensing in Diagnostics and Drug Discovery. Angewandte Chemie (International ed in English). 2018.

29. Peveler W J, Landis R F, Yazdani M, Day J W, Modi R, Carmalt C J, et al. A Rapid and Robust Diagnostic for Liver Fibrosis Using a Multichannel Polymer Sensor Array. Advanced Materials. 2018; 30(28).

30. Li W, Liu H, Xie D, He Z, Pi X. Lung Cancer Screening Based on Type-different Sensor Arrays. Sci Rep. 2017; 7.

31. Peng G, Hakim M, Broza Y Y, Billan S, Abdah-Bortnyak R, Kuten A, et al. Detection of lung, breast, colorectal, and prostate cancers from exhaled breath using a single array of nanosensors. British Journal of Cancer. 2010; 103(4):542-51.

32. Peveler W J, Roldan A, Hollingsworth N, Porter M J, Parkin I P. Multichannel Detection and Differentiation of Explosives with a Quantum Dot Array. Acs Nano. 2016; 10(1):1139-46.

33. Diehl K L, Anslyn E V. Array sensing using optical methods for detection of chemical and biological hazards. Chem Soc Rev. 2013; 42(22):8596-611.

34. El Barbri N, Llobet E, El Bari N, Correig X, Bouchikhi B. Electronic nose based on metal oxide semiconductor sensors as an alternative technique for the spoilage classification of red meat. Sensors. 2008; 8(1):142-56.

35. Wu C, Du Y-W, Huang L, Galeczki Y B-S, Dagan-Wiener A, Naim M, et al. Biomimetic Sensors for the Senses: Towards Better Understanding of Taste and Odor Sensation. Sensors. 2017; 17(12).

36. Peveler W J, Binions R, Hailes S M V, Parkin I P. Detection of explosive markers using zeolite modified gas sensors. Journal of Materials Chemistry A. 2013; 1(7):2613-20.

37. Peng G, Tisch U, Adams O, Hakim M, Shehada N, Broza Y Y, et al. Diagnosing lung cancer in exhaled breath using gold nanoparticles. Nature Nanotechnology. 2009; 4(10):669-73.

38. Saha K, Agasti S S, Kim C, Li X, Rotello V M. Gold Nanoparticles in Chemical and Biological Sensing. Chem Rev. 2012; 112(5):2739-79.

39. Maier S A. Plasmonics: Fundamentals and Applications. New York: Springer Science+Business Media LLC; 2007.

40. Srisombat L, Jamison A C, Lee T R. Stability: A key issue for selfassembled monolayers on gold as thin-film coatings and nanoparticle protectants. Colloids and Surfaces a-Physicochemical and Engineering Aspects. 2011; 390(1-3):1-19.

41. Nicosia C, Huskens J. Reactive self-assembled monolayers: from surface functionalization to gradient formation. Materials Horizons. 2014; 1(1):32-45.

42. Sperling J R, Macias G, Neale S L, Clark A W. Multilayered Nanoplasmonic Arrays for Self-Referenced Biosensing. ACS Applied Materials & Interfaces. 2018.

43. Jani A M M, Anglin E J, McInnes S J P, Losic D, Shapter J G, Voelcker N H. Nanoporous anodic aluminium oxide membranes with layered surface chemistry. Chem Commun (Cambridge). 2009(21):3062-4.

44. Goldstein J I, Newbury D E, Micheal J R, Ritchie N W M, Scott J H J, Joy D C. Scanning Electron Microscopy and X-Ray Microanalysis. 4 ed: Springer; 2017.

45. Koberstein J T. Molecular design of functional polymer surfaces. Journal of Polymer Science Part B-Polymer Physics. 2004; 42(16):2942-56.

46. Wold S, Esbensen K, Geladi P. PRINCIPAL COMPONENT ANALYSIS. Chemometrics and Intelligent Laboratory Systems. 1987; 2(1-3):37-52.

47. Guo L, Jackman J A, Yang H-H, Chen P, Cho N-J, Kim D-H. Strategies for enhancing the sensitivity of plasmonic nanosensors. Nano Today. 2015; 10(2):213-39.

48. Su K H, Wei Q H, Zhang X, Mock J J, Smith D R, Schultz S. Interparticle coupling effects on plasmon resonances of nanogold particles. Nano Lett. 2003; 3(8):1087-90.

49. Liu X M, Thomason J L, Jones F R. The Concentration of Hydroxyl Groups on Glass Surfaces and Their Effect on the Structure of Silane Deposits. Silanes and Other Coupling Agents, Vol 5. 2009:25-38.

50. Stewart S, Ivy M A, Anslyn E V. The use of principal component analysis and discriminant analysis in differential sensing routines. Chem Soc Rev. 2014; 43(1):70-84.

1.-9. (canceled)

10. A method of analysing a fluid comprising a mixture of two or more analytes, including the step of providing a surface plasmonic sensing device comprising:
a substrate;
a first array of localised surface plasmon resonance island structures on the substrate;
a second array of localised surface plasmon resonance island structures on the substrate,
wherein:
the localised surface plasmon resonance island structures of the first and second array respectively have first and second surface functionalisation for selective interaction with respective analytes;
the first surface functionalisation is different to the second surface functionalisation; and
the method further comprising the steps:
contacting the first and second arrays with said fluid comprising a mixture of two or more analytes and thereby allowing the analytes selectively to interact with the surface functionalisations available on the first and second arrays of localised surface plasmon resonance island structures;
illuminating the first and second arrays with electromagnetic radiation to cause localised surface plasmon resonance in the composite array;
receiving reflected or transmitted electromagnetic radiation from the composite array and detecting said localised surface plasmon resonance to analyse one or more characteristics of said analytes;
obtaining transmission spectra for the reflected or transmitted electromagnetic radiation from the arrays;
determining from each transmission spectrum at least one spectral characteristic value; and
arranging said spectral characteristic values in a data matrix and carrying out linear discriminant analysis (LDA) on the data matrix to classify the data in the data matrix.

11. A method according to claim 10 wherein the interaction of the analytes with the surface functionalisation selectively alters the refractive index around the localised surface plasmon resonance island structures to thereby selectively alter the localised surface plasmon resonance response.

12. A method according to claim 10 wherein the surface plasmonic sensing device further comprises a reference sensing region, wherein the reference sensing region comprises:
a first reference array of localised surface plasmon resonance island structures on the substrate;
a second reference array of localised surface plasmon resonance island structures on the substrate,
wherein:
the surface plasmon resonance island structures of the first and second reference array have no surface functionalisation or respectively have different surface functionalisation compared with the main sensing region; and
the first and second reference arrays are interspersed with each other to provide a composite reference array,
the method further comprising the steps:
contacting the reference sensing region with said fluid comprising said mixture of two or more analytes;
illuminating the reference sensing region with electromagnetic radiation to cause localised surface plasmon resonance in the composite reference array; and
receiving reflected or transmitted electromagnetic radiation from the composite reference array and detecting said localised surface plasmon resonance for comparison with the main sensing region.

13. A method according to claim 12 wherein the reference sensing region is selectively illuminated.

14. A method according to claim 10 wherein the surface plasmonic sensing device further comprises an auxiliary sensing region, wherein the auxiliary sensing region comprises:
a first auxiliary array of localised surface plasmon resonance island structures on the substrate;
a second auxiliary array of localised surface plasmon resonance island structures on the substrate,
wherein:
the surface plasmon resonance island structures of the first and second auxiliary array respectively have first and second auxiliary surface functionalisation for selective interaction with respective analytes;
the first auxiliary surface functionalisation is different to the second auxiliary surface functionalisation; and
the first and second auxiliary arrays are interspersed with each other to provide a composite auxiliary array,
the method further comprising the steps:
contacting the auxiliary sensing region with said fluid comprising said mixture of two or more analytes and thereby allowing the analytes selectively to interact with the surface functionalisations available on the first and second arrays of localised surface plasmon resonance island structures;
illuminating the auxiliary sensing region with electromagnetic radiation to cause localised surface plasmon resonance in the composite auxiliary array; and
receiving reflected or transmitted electromagnetic radiation from the composite auxiliary array and detecting said localised surface plasmon resonance to analyse one or more characteristics of said analytes and/or for comparison with the main sensing region.

15. A method according to claim 14 wherein the auxiliary sensing region is selectively illuminated.

16.-27. (canceled)
